(19) United States
(12) Patent Application Publication
(10) Pub. No.: US 2006/0167748 A1
(43) Pub. Date: Jul. 27, 2006

(54) Public/private campaign management for an internet sales application

(76) Inventors: Joachim Hartmann, St. Ingbert (DE); Stefan Broeckel, Marpingen (DE); Michael P. Dietrich, Bexbach (DE); Michelle Green, Bloomfield Hills, MI (US)

Correspondence Address: KENYON & KENYON LLP, ONE BROADWAY, NEW YORK, NY, 10004, US

(21) Appl. No.: 11/042,995

(22) Filed: Jan. 25, 2005

(51) Int. Cl. G06Q 30/00

(52) U.S. Cl. 705/14

(57) ABSTRACT

The present invention provides a system and method for managing marketing campaigns by sales applications. Sales applications manage campaigns by distinguishing among campaigns for marketing purposes. A customer who is browsing a sales application may be queried for a campaign code. The sales application will then retrieve an indicator of whether the campaign is a public campaign or a private campaign. If the campaign is a public campaign, the sales application will provide the user access. If the campaign is a private campaign, the sales application will require user authentication before the application will display and/or charge the customer discounted rates or provide other purchasing incentives. If a customer cannot provide the proper identification information, the application will not allow access to the private rate. Thus, proprietors may distinguish between marketing campaigns and require user authentication for access to private campaigns.

### BACKGROUND

Information and computer technology comprises an essential component for modern business operations. The utility of computer technology has been enhanced by the coupling of computers with information networks such as the Internet and World Wide Web (“WWW”). For example, software applications provide Internet sales environments, which may also be referred to as “web shops.” Internet sales applications provide products and pricing information to computer terminals permitting customers located at the terminals to browse through product offerings, select products for purchase and arrange for payment and delivery.

An Internet sales application may also permit a customer to take advantage of a marketing campaign. Campaigns, which may also be referred to as sales promotions, entice prospective customers to purchase products by offering price discounts or other incentives associated with purchase. Campaigns may be advertised widely. To take advantage of a discount, a customer may be required to submit a code to identify the promotion or campaign. For access to some campaigns, user login and authentication may be required. After the customer provides the code, and identification information, if required, the customer is charged only the discounted prices that are associated with the campaign.

Since campaigns are advertised widely, campaign codes may be distributed to many individuals. However, a web shop proprietor may want to limit who can take advantage of some marketing campaigns, while allowing the public access to other campaigns. Management of campaigns by Internet sales applications is needed to provide proprietors with the ability to distinguish among campaigns for marketing purposes.

### BRIEF DESCRIPTION OF THE DRAWINGS

FIG. 1 illustrates a computer system block diagram according to one embodiment of the invention.

FIG. 2 illustrates a campaign management system software architecture according to one embodiment of the invention.

FIG. 3 depicts a data flow diagram for providing a graphical user interface according to one embodiment of the present invention.

FIG. 4 shows a flowchart of user access according to one embodiment of the present invention.

FIG. 5 shows a structure of a server according to one embodiment of the invention.

### DETAILED DESCRIPTION

The present invention provides a system and method for managing marketing campaigns by sales applications. Sales applications manage campaigns by distinguishing among campaigns for marketing purposes. A customer who is browsing a sales application may be queried for a campaign code. The sales application will then retrieve an indicator of whether the campaign is a public campaign or a private campaign. If the campaign is a public campaign, the sales application will provide the user access. If the campaign is a private campaign, the sales application will require user authentication before the application will display and/or charge the customer discounted rates or provide other purchasing incentives. If a customer cannot provide the proper identification information, the application will not allow access to the private rate. Thus, proprietors may distinguish between marketing campaigns and require user authentication for access to private campaigns.

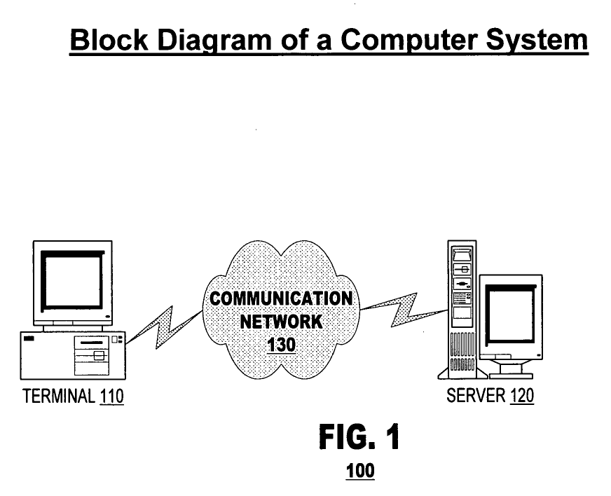

FIG. 1 illustrates a computer system block diagram 100 according to one embodiment of the invention. The computer system may comprise a terminal 110 that is connected to a server 120 via a communication network 130 to access a sales application that allows customers to obtain discounts offered by marketing campaigns.

A customer located at the terminal 110 may interact with a sales application that is processed by the server 120. The sales application may be any set of files (e.g., executables, configuration files, and/or ancillary files) that provide programs customized for sale of goods and/or services. In an alternate embodiment of the invention, the sales application need not involve a transfer of money but may instead be used for donations or any other transactions that involve transfer of goods or services under specified terms. The sales application may reside on the server 120. The sales application may be accessed via the communication network 130, which may be the Internet or any other wired and/or wireless network. The communication network 130 may also be a single connection between terminal 110 and server 120. In another alternate embodiment of the invention, a single processor performs the functions of the terminal 110 and the server 120.

The terminal 110 may display one or more graphical user interfaces to a customer so that the customer can navigate through the sales application, browse product offerings and select items for purchase. The graphical user interfaces may provide descriptions of the products, as well as prices of the products and a field so that a customer may enter a campaign code. If the customer enters a code corresponding to a private campaign, a pane may be presented to the customer so that the customer can enter user dentification information. When a campaign code is entered, and, for private campaigns, authentication is complete, a graphical user interface may present a customer with discounted prices or other financial terms that are associated with the campaign. The terminal 110 may be any device having an input and output through which a customer can interact with the server 120 (e.g., a client computer, personal data assistant or cellular telephone having a graphical user interface (GUI) or a Web browser).

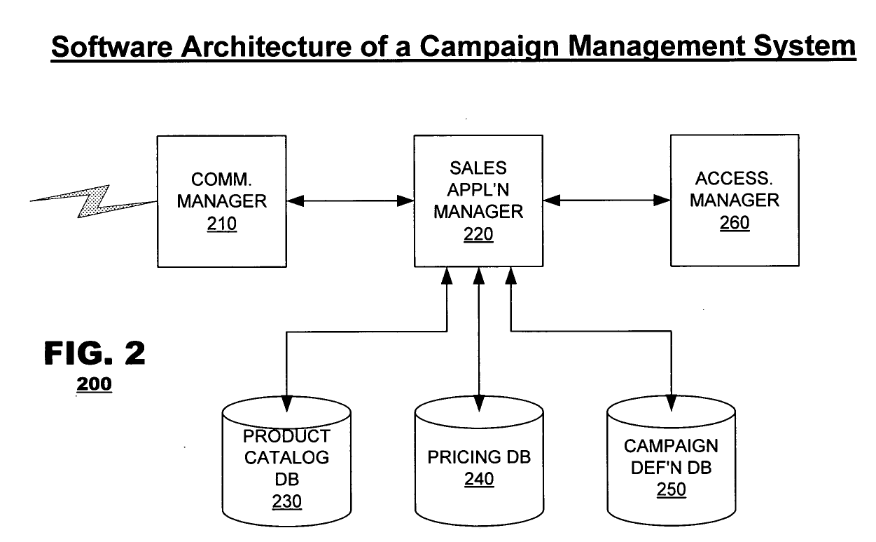

FIG. 2 illustrates a campaign management system software architecture 200 according to one embodiment of the invention. The campaign management system software may reside in and be processed by server 120. The campaign management system software architecture 200 comprises a sales application manager 220 that manages processing performed by the sales application. The sales application manager 220 is connected to a product catalog database 230 that stores product descriptions and a pricing database 240 that stores list prices. The sales application manager 220 is also connected to a campaign definition database 250 that stores the campaign category and other campaign information. Customer identification information is authenticated by an access manager 260, which is also connected to the sales application manager 220. The sales application manager 220 is connected to a communications manager 210 so that the communications manager 210 can manage communications with external devices.

The sales application manager 200 collects data that will be displayed via, for example, graphical user interfaces that provide product browsing, pricing information, acceptance and validation of campaign codes, and product selection and checkout.

The sales application manager 200 retrieves product information from the product catalog database 230 and pricing information from the pricing database 240 and presents this information to the customer via graphical user interfaces. The product catalog 230 stores data describing products, e.g., goods and/or services offered via the sales application. The descriptions may characterize the product's capabilities, benefits or failures.

The pricing database 240 stores list prices offered for the products and/or services.

The pricing database 240 may store various sets of data for the same product, if the list price changes during the lifecycle of the product. Exemplary data stored by a pricing database 240 is below.

| Product | Public Price |
|---|---|
| Basic Notebook Computer Model No. 1000 | 1032.48 USD |
| Basic Notebook Computer Model No. 1001 | 1348.92 USD |
| Professional Notebook Computer Model No. 1010 | 2158.92 USD |
| Professional Notebook Computer Model No. 1011 | 2482.92 USD |

The proprietor may offer marketing campaigns that are promoted via a sales brochure, flyer, catalog or some other advertising medium. Marketing campaigns may be private and only available for members. A proprietor may offer a discount to certain customers who have obtained a membership, perhaps at a fee or because the customer regularly purchases above a threshold quantity of a product. To receive the benefits of a private marketing campaign, a customer has to identify that he or she is a member. A proprietor may also choose to offer a public campaign. For both private and public campaigns, a customer may be queried for a campaign code prior to receiving information on discounts or other marketing incentives. A campaign code, which may also be referred to as a campaign identifier, may be any information that that identifies the campaign, e.g., a series of characters or numbers. A campaign database 250 may store data representing parameters of various campaigns, both public and private. The campaign database 250 may store campaign identifiers, also referred to as campaign codes, whether the campaign is public or private, discounted pricing information and/or any other financial terms. Discounted pricing information and/or other financial terms may include an offer of a free item with purchase of another item or any other incentives. Exemplary data stored by a campaign database 250 is shown below.

| | | Public | | Public | Member |
|---|---|---|---|---|---|
| Campaign | Campaign | or | Product | Campaign | Campaign |
| Description | Identifier | Private? | Offered | Price | Price |
| Consumer | ABC | Public | Basic | 1000.00 | Not |
| Products | | | Notebook | USD | Applicable |
| Marketing | | | Computer | | |
| Campaign | | | Model No. | | |
| | | | 1000 | | |
| Business | XXX | Private | Professional | Not | 2000.00 |
| Products | | | Notebook | Applicable | USD |
| Marketing | | | Computer | | |
| Campaign | | | Model No. | | |
| | | | 1010 | | |
| New | ZZZ | Private | Basic | Not | 1150.00 |
| Products | | | Notebook | Applicable | USD |
| Marketing | | | Computer | | |
| Campaign | | | Model No. | | |
| | | | 1001 | | |
| | | | Professional | Not | 2175.00 |
| | | | Notebook | Applicable | USD |
| | | | Computer | | |
| | | | Model No. | | |
| | | | 1011 | | |

The access manager 260 stores valid customer profile data to authenticate user identification information. A proprietor may require that members of a discount program maintain profile data which may include any one or more strings of characters that may used to identify a customer such as a user name, password and/or telephone number so that customers who participate in a discount program can be distinguished from those who do not. The access manager 260 stores the customer profile data and, when requested, provides this information to the sales application manager 220 so that the sales application manager 220 can compare it to information received from the customer. Since a sales application 220 may sell products and services provided by multiple vendors, the access manager 260 may store different types of customer profile data. Exemplary data stored by an access manager 260 is shown below.

| Vendor | Access Required? | User Identifier | User Password |
|---|---|---|---|
| ABC Inc. | Yes | jsmith | 111111 |
| | | rsmith | 222222 |
| | | jjones | 333333 |
| XYZ Inc. | Yes | 1 (212) 111-1111 | None required |
| | | 1 (212) 222-2222 | None required |

The sales application manager 220 sends and receives data via the communication manager 210. The communication manager 210 may support interactive communications with the operator of the terminal 110. The communication manager 210 may present the data to a user by, for example, creating a graphical user interface. Data may be stored by the product catalog 230, the pricing database 240, the campaign definition database 250 and the access manager 260 in look-up tables, as part of objects that are retrieved using object-oriented code or using any other method for addressing memory to store and retrieve data. For example, an object may be stored corresponding to each campaign. This object may maintain data for that campaign.

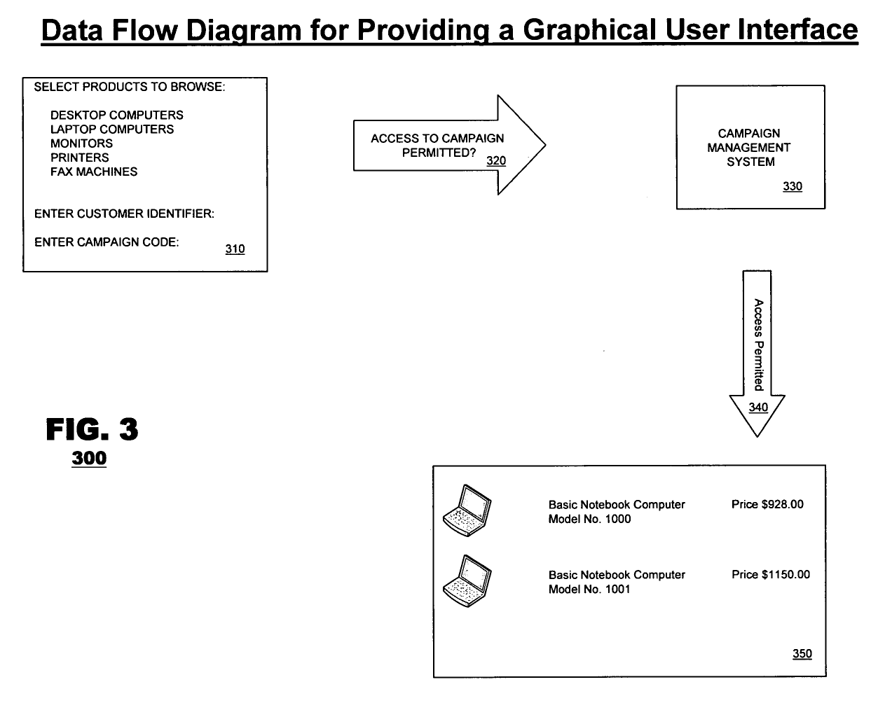

FIG. 3 depicts a data flow diagram for providing a graphical user interface 300 according to one embodiment of the invention. A user, such as a customer, may access a sales application to browse product offerings and make purchases. A customer typically will enter an address such as a Uniform Resource Locator (URL) of an entry point such as a home page of the sales application. A URL is an address that defines a route to a file on a World Wide Web (HTTP) server. The user will then be presented with the home page of the sales application and can navigate the sales application to browse product or service offerings.

The sales application may present a first screen 310 with a query to a user for types of products and/or services that the user would like to browse. The sales application may also query the user for identification information and one or more campaign codes and store this data in temporary storage, such as in a cache, so that it can be retrieved multiple times without requiring the user to re-enter the data. In an alternate embodiment of the invention, the sales application does not store data temporarily in storage. Instead a login screen appears each time the user enters a private campaign code so that the user can enter identification information. Multiple campaign codes may be entered to identify multiple marketing campaigns. A query sent by the sales application manager 220 may also include options of various types of identification information that may be entered, any one of which, if valid, will permit the user to obtain access to private pricing discounts. Exemplary user identification data may include a user name, such as jsmith, and a user password, such as 111111, or a telephone number, such as (212) 111-1111, or any other series of characters that may be used to identify a particular individual or entity.

If the user enters a campaign code and customer identification information, the terminal 110 may send a message 320 to determine whether the campaign code corresponds to a private campaign, and if so, whether the user is authorized access to the campaign. For example, if the user enters a customer identifier of (212) 111-1111 , a campaign code of ZZZ corresponding to a particular marketing campaign, i.e., the “new products marketing campaign” and selects to browse laptop computers manufactured by XYZ Inc., a message 320 will be sent to the customer management system comprising the customer identifier “1 (212) 111-1111 ,” the campaign code “ZZZ,” and the request to browse notebook computers manufactured by XYZ Inc. The message 320 may be sent to a campaign management system 330 residing on the server 120.

The campaign management system 330 will determine whether the campaign identified is a public or private campaign, and if the campaign is private, whether the user is authorized access to the selected campaign. If the user is authorized access, the campaign management system 330 will send data 340 to display a second screen 350 displaying products that the user selected as well as private pricing data corresponding to the selected products.

In the example above, since ZZZ is a valid campaign code and 1 (212) 111-1111 is a valid customer identifier for XYZ Inc., private pricing data (1150.00 USD and 2175.00 USD) will be displayed in the second screen 350. If the customer had not provided a valid customer identifier, the public pricing data (1348.92 USD and 2498.98 USD) would have been displayed instead.

As the user selects products for purchase, the sales application may query the user to purchase products that have been selected for purchase. If the user chooses to purchase the selected products, the sales application manager 220 may proceed to checkout. In an alternate embodiment of the invention, solicitation of campaign identification information and authentication may be performed during check out. In this embodiment, a checkout screen may query the user for a campaign code and/or customer identification information. The checkout screen may include a field for customer identification information and/or a campaign code. A modified checkout screen with public or private pricing data may be displayed in response to this information.

If the sales application manager 220 supports products provided by different vendors, the sales application manager 220 may query the user for multiple user identifiers, passwords and/or campaign codes corresponding to each vendor. For example, each line item presented in the checkout page may include a field for a user identifier and/or password and a campaign code. Alternatively, the sales application manager 220 may identify manufacturers or service providers associated with the products selected and provide a screen corresponding to the identified proprietor so that the user can enter user identification information and/or campaign codes for each identified proprietor without the need to re-enter the data for each product provided by a particular proprietor.

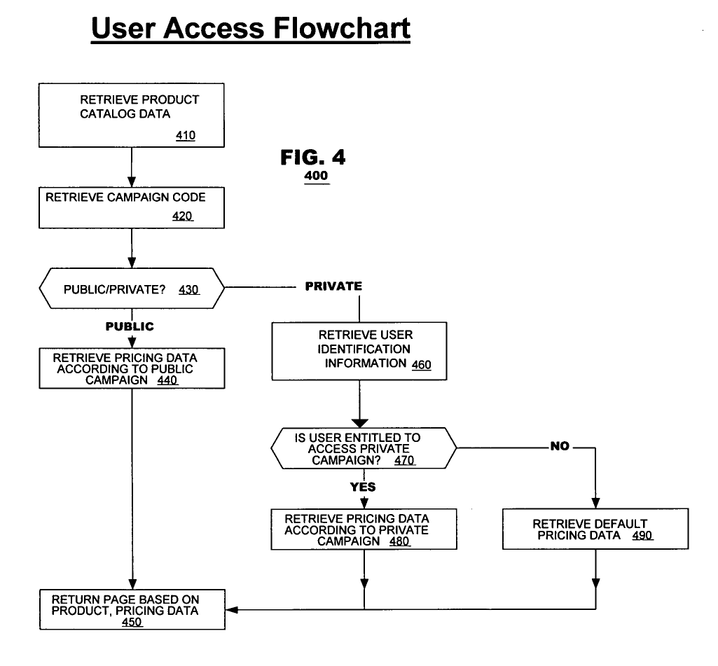

FIG. 4 shows a flowchart of user access 400 according to one embodiment of the present invention. A user may attempt to access campaign pricing while browsing products for purchase or during checkout. The user may initiate the process by selecting products either to browse or to purchase and by entering a campaign code and authentication information.

In step 410, the sales application manager 220 retrieves descriptions from the product catalog database 230 corresponding to the products and/or services selected by the user for browsing. Descriptions may include identification of the item or service for sale, characterizations of features of the item or service, and perhaps pictures of items for sale. For example, a user may choose to browse laptop computers manufactured by XYZ Inc. The sales application manager 220 may retrieve descriptions of various laptop computers available including a model number, processing speed, memory and other features and capabilities of the device. If the sales application stores data for products made by different manufacturers, a manufacturer name may also be included in a product description.

In an alternate embodiment of the invention, user access is performed at checkout. In this embodiment of the invention, the user has already selected products and/or services after browsing product and/or service offerings and has selected to purchase the items. The application manager 220 retrieves data from the product catalog database 230 that corresponds to the products or services selected by the user for purchase. For example, if the user has selected to purchase a Basic Notebook Computer Model No. 1000 manufactured by XYZ Inc., the sales application manager 220 will retrieve a product description corresponding to that device.

In step 420, the sales application manager 220 retrieves a campaign code entered by the user. The terminal 110 may send the campaign code in a message and the sales application manager 220 may store the campaign code temporarily, for example, in a cache. In the example above, if the user enters a campaign code of “ZZZ” corresponding to a new products marketing campaign, a campaign code of “ZZZ” may be retrieved from temporary storage. In an alternate embodiment of the invention, the campaign code is received directly from the user.

In step 430, the software application manager 220 determines whether the user entered a campaign code corresponding to a public or a private campaign. The software application manager 220 compares the campaign code entered by the user to campaign codes stored by the campaign definition database 250. For example, if the user entered a campaign code “ZZZ,” the sales application manager 220 compares “ZZZ” to the list of valid campaign codes stored by the access manager. If there is a match, an indicator of whether the campaign code corresponds to a public campaign or a private campaign is retrieved from the campaign definition database 250. The indicator may be stored as a field in a look-up table, may be set by a flag, or may be stored with an object representing the campaign. In the example set forth above, the campaign code “ZZZ” corresponds to a private campaign.

If the campaign code entered by the user corresponds to a campaign that offers only one discounted rate for both private members and the public, processing may proceed to step 440. In the example set forth above, the campaign code “ABC” corresponds to a campaign that offers the same discounted rate for private members and the public. If an operator enters the campaign code “ABC,” processing may proceed to step 440 since authentication is not needed to obtain the lowest discounted price. The campaign codes ”)XX” and “ZZZ” both are associated with private campaigns that offer discounts for private members. Authentication is required to access these campaigns so that qualifying members may be offered lower prices.

In step 440, public pricing data is retrieved from the campaign definition database 250. Public pricing data corresponding to the campaign code is retrieved from the campaign definition database 250 corresponding to the product catalog data that was retrieved in step 410. The pricing data is stored temporarily along with the product catalog data for presentation to the user. In an alternate embodiment of the invention, the campaign may be limited to members. In this embodiment of the invention, no public pricing data is available for the campaign and public pricing is retrieved from the pricing database 240. In step 450, a page is returned based on the product and pricing data that was retrieved. The page may be presented to the user via, for example, a graphical user interface.

Step 460 is reached if the campaign code entered by the user corresponds to a private campaign. In step 460, the sales application manager 220 retrieves identification data entered by the user to determine whether the user is authorized access to the membership rate. This identification may have been received in a message sent by the terminal 110 and stored temporarily in, for example, a cache.

In step 470, the sales application manager 220 determines whether the user is entitled to receive discounts available to private members. The user identification data received from the user is compared to user identification data stored by the access manager 260. If a match is found, the user is entitled to access the private campaign. In the example set forth above, if a user enters 1 (212) 111-1111 to access an XYZ Inc. campaign, a match will be found and the user will be authorized access. If no match is found, access is not authorized. If the user has not already logged in, they are required to login.

In step 480, private pricing data is retrieved from the campaign definition database.

Private pricing data corresponding to the campaign code entered by the user is retrieved from the campaign definition database 250 corresponding to the product catalog data that was retrieved in step 410. The pricing data is stored temporarily along with the product catalog data for presentation to the user.

Step 490 is reached if no match is found for a user and the user is not authorized to receive private membership rates. In step 470, default data may be retrieved from the pricing database 240. In one embodiment of the invention, the default pricing data is the same as the list price.

In one embodiment of the invention, a proprietor may select to disguise to a user that the user has not been authorized and may even offer a slightly discounted default rate that is different that the public price. For example, if a proprietor provides discounts to corporate members but not to consumers, the proprietor may not want consumers to know that they do not qualify for the lowest rate. The proprietor may offer a slightly discounted rate to consumers who attempt to demonstrate that they are authorized for private corporate rates. This default data may be retrieved from the campaign definition database 250.

In an alternate embodiment of the invention, if no match is found a user may be presented with the option to become a member. If the user selects to become a member, the user may navigate screens to obtain membership. After membership is obtained, processing may return to step 410. If a match is found in step 470, processing proceeds to step 480.

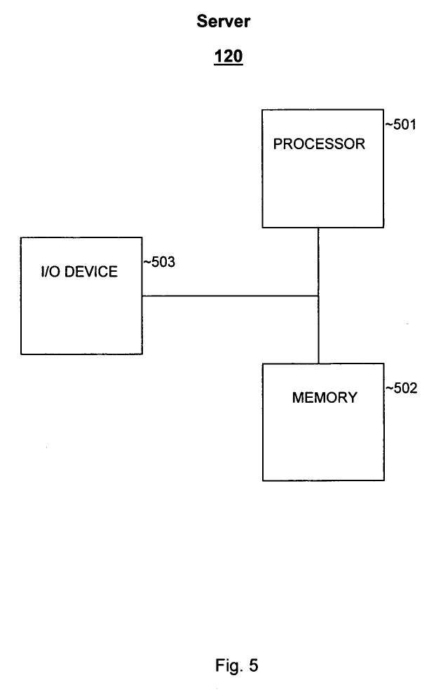

FIG. 5 shows a structure of a server 120 according to one embodiment of the invention. The server 120 includes a processor 501, memory 502, and an input/output (I/O) device 503. The processor 501 is connected to the memory 502. The processor 501 is also connected to the I/O device 503. These connections are direct or via other internal electronic circuitry or components.

The processor 501 may be any programmable processor that executes instructions residing in memory 502 to receive and send data via the I/O device 503 including any programmable microprocessor or combination of microprocessors or processors that can operate on digital data, which may be special or general purpose processors coupled to receive data and instructions from, and to transmit data and instructions to, a machine-readable medium. According to one embodiment of the present invention processor 401 is an Intel microprocessor.

Memory 502 may be any machine-readable medium that stores data that is processed by the processor 501 including any computer program product, apparatus and/or device (e.g., a random access memory (RAM), read only memory (ROM), magnetic disc, optical disc, programmable logic device (PLD), tape, or any combination of these devices). This may include external machine-readable mediums that are connected to the processor 501 via the I/O device 503.

The I/O device 503 may be any coupling that receives and/or send digital data to and from an external device.

Various implementations of the systems and techniques described here can be realized in any processing systems and/or digital electronic circuitry, integrated circuitry, specially designed ASICs (application specific integrated circuits), computer hardware, firmware, software, and/or combinations thereof.

A number of embodiments of the invention have been described. Nevertheless, it will be understood that various modifications may be made without departing from the spirit and scope of the invention.

What is claimed is:

1. A method for managing a campaign comprising:
responsive to receipt of a campaign code from a user, determining whether a campaign corresponding to the received code is a public campaign or a private campaign;
if the campaign is the private campaign, based on user identification information, determining whether the user has access rights to the campaign corresponding to the campaign code;
if so, retrieving rates associated with the campaign and presenting the rates to the user;
if not, retrieving second rates and presenting the second rates to the user.

2. The method of claim 1 wherein the user may enter any one of multiple identifiers to obtain access to rates of the private campaign.

3. The method of claim 1 wherein the user identification information is a telephone number, a password or a user name.

4. The method of claim 1 wherein the user identification information is a first type to access the rates offered by a first manufacturer and is a second type to access third rates offered by a second manufacturer.

5. The method of claim 1 wherein the user identification information is stored temporarily and is retrieved to determine if the user has access rights to the campaign without the user re-entering the information.

6. The method of claim 1 wherein the user is prompted for user identification information each time the user attempts to access rates for the private campaign.

7. The method of claim 1 wherein the user is prompted for user identification information while the user is checking out of an Internet sales application.

8. The method of claim 1 wherein the management of the campaign is performed by an Internet sales application.

9. A method for managing a campaign comprising:
comparing campaign identification data supplied by a user to valid campaign identifiers;
upon identification of a match, retrieving an indicator corresponding to the campaign that indicates whether the campaign is private or public;
if the code corresponds to a private campaign, comparing user identification data supplied by the user to valid customer profile data; and
upon identification of a second match, retrieving financial terms for the private campaign;
presenting the financial terms and corresponding product catalog data to the user.

10. A system for managing a campaign comprising:
a sales application manager for displaying graphical user interfaces providing product or service descriptions and pricing information;
a campaign definition database for storing data defining a marketing campaign including private pricing data; and
an access manager for storing valid customer profile data to compare to user input for authentication and access to private pricing data;
wherein said sales application manager displays private pricing data upon authentication of said user input and default pricing data if said user input is not authenticated.

11. The system of claim 10 further comprising a product catalog database that stores product data describing goods or services that are offered for sale by the sales application manager.

12. The system of claim 10 further comprising a pricing catalog database that stores default pricing data.

13. The system of claim 10 wherein the default pricing data is a list price.

14. The system of claim 10 wherein the default pricing data is data other than the list price that is displayed when the user attempts authentication.

15. The system of claim 10 wherein the data defining a marketing campaign is stored in the form of objects.

16. The system of claim 10 further comprising a communication manager for displaying graphical user interfaces to present private pricing data or default pricing data to a user.

17. In a sales application, a graphical user interface comprising:
a first spatial area of display to display fields for receiving user identification data and campaign identification data from a user; and
a second spatial area of display to display pricing data corresponding to products or services selected by said user upon verification of said campaign identification data;
wherein said sales application displays private pricing data upon authentication of said user input and public pricing data if said user input is not authenticated.

18. The graphical user interface of claim 17 wherein the first spatial area of display displays descriptions of products selected by a user for purchase and a user identification field for each selected product.

19. The graphical user interface of claim 17, wherein the first spatial area of display further displays a campaign code for each selected product.

20. A computer readable medium storing thereon program instructions that, when executed, cause an executing device to:
responsive to receipt of a campaign code from a user, determine whether a campaign corresponding to the received code is a public campaign or a private campaign;
if the campaign is the private campaign, based on user identification information, determine whether the user has access rights to the campaign corresponding to the campaign code;
if so, retrieve rates associated with the campaign and present the rates to the user;
if not, retrieve second rates and present the second rates to the user.

21. The computer readable medium of claim 20 wherein the user may enter any one of multiple identifiers to obtain access to rates of the private campaign.

22. The computer readable medium of claim 20 wherein the user identification information is a telephone number, a password or a user name.

23. The computer readable medium of claim 20 wherein the user identification information is a first type to access the rates offered by a first manufacturer and is a second type to access third rates offered by a second manufacturer.

24. The computer readable medium of claim 20 wherein the user identification information is stored temporarily and is retrieved to determine if the user has access rights to the campaign without the user re-entering the information.

25. The computer readable medium of claim 20 wherein the user is prompted for user identification information each time the user attempts to access rates for the private campaign.

26. The computer readable medium of claim 20 wherein the user is prompted for user identification information while the user is checking out of an Internet sales application.

27. The computer readable medium of claim 20 wherein the management of the campaign is performed by an Internet sales application.

28. A computer readable medium storing thereon program instructions that, when executed, cause an executing device to:
compare campaign identification data supplied by a user to valid campaign identifiers;
upon identification of a match, retrieve an indicator corresponding to the campaign that indicates whether the campaign is private or public;
if the code corresponds to a private campaign, compare user identification data supplied by the user to valid customer profile data;
upon identification of a second match, retrieve financial terms for the private campaign; and
present the financial terms and corresponding product catalog data to the user.
